(19) United States
(12) Patent Application Publication
(10) Pub. No.: US 2021/0034049 A1
(43) Pub. Date: Feb. 4, 2021

(54) REMOTE DRIVING SYSTEM AND REMOTE DRIVING METHOD

(71) Applicant: TOYOTA JIDOSHA KABUSHIKI KAISHA, Toyota-shi (JP)

(72) Inventors: Yosuke TOKUDA, Toyota-shi (JP); Masahiro NISHIO, Toyota-shi (JP); Shuichiro TAKAHASHI, Toyota-shi (JP); Haruka YANO, Toyota-shi (JP); Taichi AMAKASU, Toyota-shi (JP)

(73) Assignee: TOYOTA JIDOSHA KABUSHIKI KAISHA, Toyota-shi (JP)

(21) Appl. No.: 16/936,931

(22) Filed: Jul. 23, 2020

(30) Foreign Application Priority Data
Jul. 30, 2019 (JP) 2019-140166

(51) Int. Cl. G05D 1/00; B60W 40/08; B60W 50/14; B60R 22/48

(52) U.S. Cl. CPC G05D 1/0011; B60W 40/08; B60W 50/14; B60R 2022/4808; B60W 2540/043; B60W 2540/221; B60R 22/48

(57) ABSTRACT

A first processor provided in a manual operation device of a vehicle, a second processor provided in a remote operation device transmits operator information to the manual operation device and receives occupant information. The first processor notifies an occupant of the received operator information, and determines whether an operator can be authenticated by the occupant. The second processor notifies the operator of the received occupant information, and determines whether or not the occupant can be authenticated by the operator. The third processor permits switching of driving operation from one to another of the manual operation device and the remote operation device only in a case in which the operator has been determined authenticable by the first processor and the occupant has been determined authenticable by the second processor.

### CROSS-REFERENCE TO RELATED APPLICATION

This application is based on and claims priority under 35 USC 119 from Japanese Patent Application No. 2019-140166 filed on Jul. 30, 2019, the disclosure of which is incorporated by reference herein.

### BACKGROUND

### Technical Field

The present disclosure relates to a remote driving system and a remote driving method.

### Related Art

Japanese Patent Application Laid-Open No. 2018-62223 discloses a system in which a central control detects whether or not a vehicle occupant has aptitude as a driver, and if the occupant does not have aptitude, the center remotely drives the vehicle.

In the remote driving system such as disclosed in Japanese Patent Application Laid-Open No. 2018-62223, only the appropriateness of the occupant is detected, and the vehicle is unilaterally driven remotely at the central control side. For this reason, when the operator at the center side lacks driving aptitude, the occupant cannot operate anything, there is a possibility that traveling failure of the vehicle may occur, and there is room for improvement.

### SUMMARY

A remote driving system according to an aspect of the present disclosure includes: a first processor that is provided at a manual operation device of a vehicle; a second processor that is provided at a remote operation device; and a third processor. The first processor is configured to transmit, to the remote operation device that performs remote operation of the vehicle, occupant information related to an occupant that performs driving operation of the manual operation device, and to receive operator information related to an operator that performs driving operation of the remote operation device. The second processor is configured to transmit the operator information to the manual operation device and to receive the occupant information. The first processor is configured to notify the occupant of the received operator information and to determine whether or not authentication of the operator by the occupant is possible. The second processor is configured to notify the operator of the received occupant information and to determine whether or not authentication of the occupant by the operator is possible. The third processor is configured to permit switching of driving operation from one to another of the manual operation device and the remote operation device only in a case in which the operator has been determined authenticable by the first processor and the occupant has been determined authenticable by the second processor.

### BRIEF DESCRIPTION OF DRAWINGS

FIG. 1 is a diagram illustrating an outline of a remote driving system according to a first embodiment.

FIG. 2 is a block diagram illustrating a hardware configuration of a manual operation unit according to the first embodiment.

FIG. 3 is a block diagram illustrating a hardware configuration of a remote operation unit according to the first embodiment.

FIG. 4 is a block diagram illustrating a functional configuration of each unit of the remote operation system according to the first embodiment.

FIG. 5A is a diagram exemplifying display content related to a remote operator displayed on a monitor of an occupant in the remote driving system according to the first embodiment.

FIG. 5B is a diagram exemplifying display content relating to the occupant displayed on the monitor of the remote operator in the remote driving system according to the first embodiment.

FIG. 6 is a flowchart illustrating a flow of a process of handing over the driving operation in the manual operation device according to the first embodiment.

FIG. 7 is a flowchart exemplifying a flow of a process of taking over a driving operation in the remote operation device according to the first embodiment.

FIG. 8 is a flowchart illustrating a flow of a process of handing over a driving operation in a permission unit according to the first embodiment.

FIG. 9 is a block diagram illustrating a hardware configuration of a manual operation device according to a second embodiment.

FIG. 10 is a block diagram illustrating a hardware configuration of a remote operation device according to the second embodiment.

FIG. 11 is a block diagram illustrating a functional configuration of each unit of the remote operation system according to the second embodiment.

FIG. 12A is a diagram exemplifying display content related to a remote operator displayed on a monitor of an occupant in the remote driving system according to the second embodiment.

FIG. 12B is a diagram exemplifying display content relating to the occupant displayed on the monitor of the remote operator in the remote driving system according to the second embodiment.

### DETAILED DESCRIPTION

### First Exemplary Embodiment

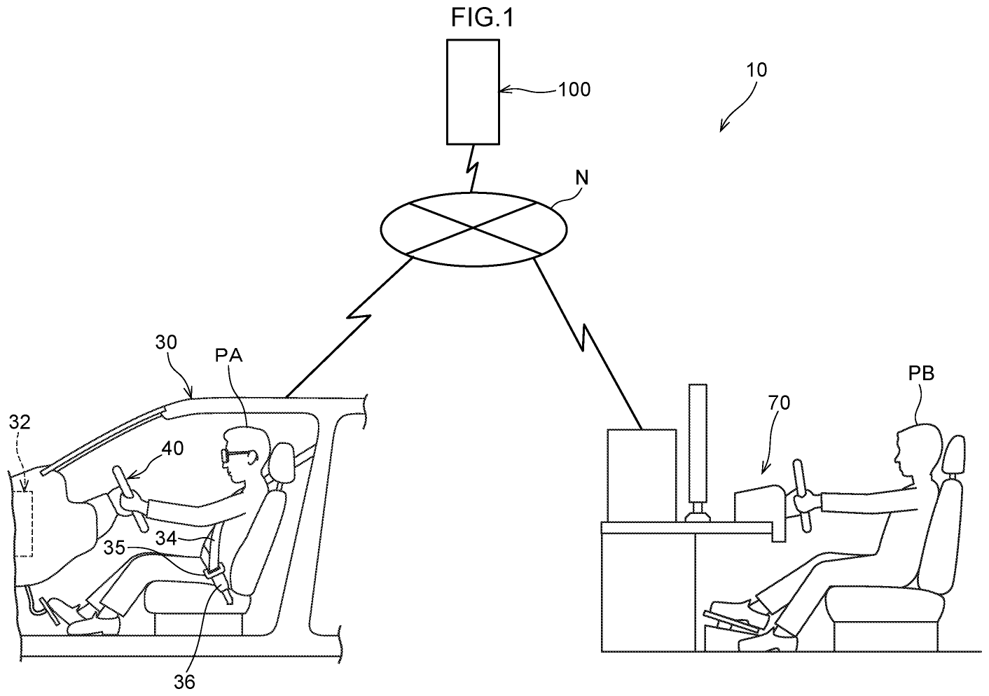

FIG. 1 illustrates an outline of a remote operation system 10. The remote driving system 10 is a system including a vehicle 30, a remote operation device 70, and a management server 100 as hardware configurations. The vehicle 30, the remote operation device 70, and the management server 100 are connected by a predetermined network N, which is an example of a communication unit, so that bidirectional information transmission is possible.

[Hardware Configuration]

The hardware configuration of the vehicle 30, the remote operation device 70, and the management server 100 will be described. The vehicle 30 is operated by an occupant PA or a remote operator PB. The remote operation device 70 is operated by a remote operator PB. The remote operator PB is an example of the operator.

<Vehicle>

The vehicle 30 may include a vehicle drive device 32, a seat belt 34, a buckle 36, and a manual operation device 40. The vehicle driving device 32 may include an engine, a transmission, and the like, and drives the vehicle 30 based on operation by the manual operation device 40 or the remote operation device 70. The seat belt 34 is inserted into a tongue plate 35. By inserting the tongue plate 35 into the buckle 36, the seat belt 34 is mounted on the occupant PA.

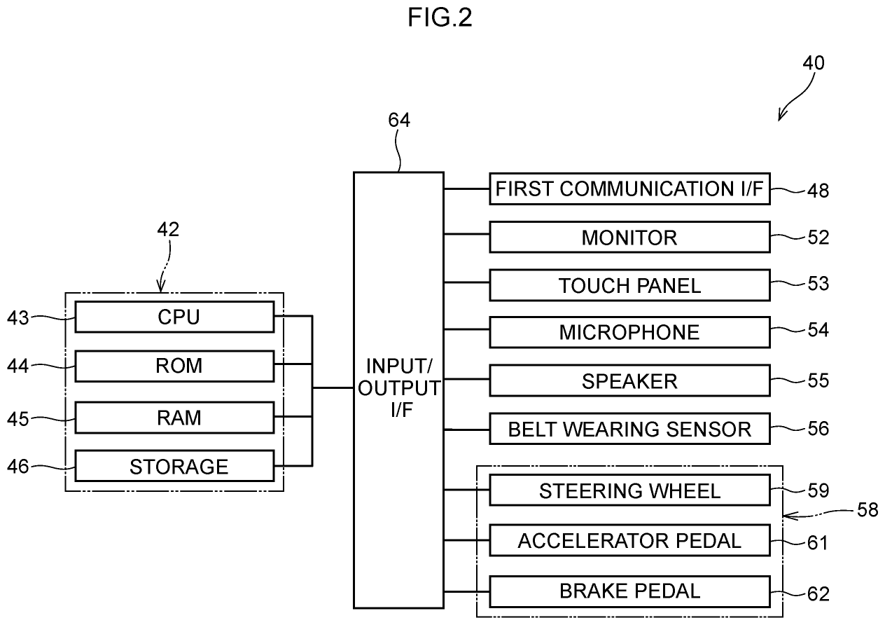

FIG. 2 shows an example of a hardware configuration of the manual operation device 40. The manual operation device 40 has an ECU 42, a first communication I/F 48, a monitor 52, a touch panel 53, a microphone 54, a speaker 55, a belt wearing sensor 56, an operation unit 58, and an input/output interface 64. In the following description, “I/F” is an abbreviation of “interface”. ECU stands for Electronic Control Unit. The ECU 42 and each of the above components are communicably connected to each other via an input/output interface 64.

The ECU 42 has a CPU 43, a ROM 44, a RAM 45, and a storage 46. CPU stands for Central Processing Unit, ROM stands for Read Only Memory, and RAM stands for Random Access Memory.

The ROM 44 stores various types of programs and various types of data. The RAM 45 acts as a workspace for temporary storage of programs and data. The storage 46 is configured by, for example, a flash ROM, and stores various programs including an operating system and various data. The CPU 43 executes various programs recorded in the ROM 44 or the storage 46.

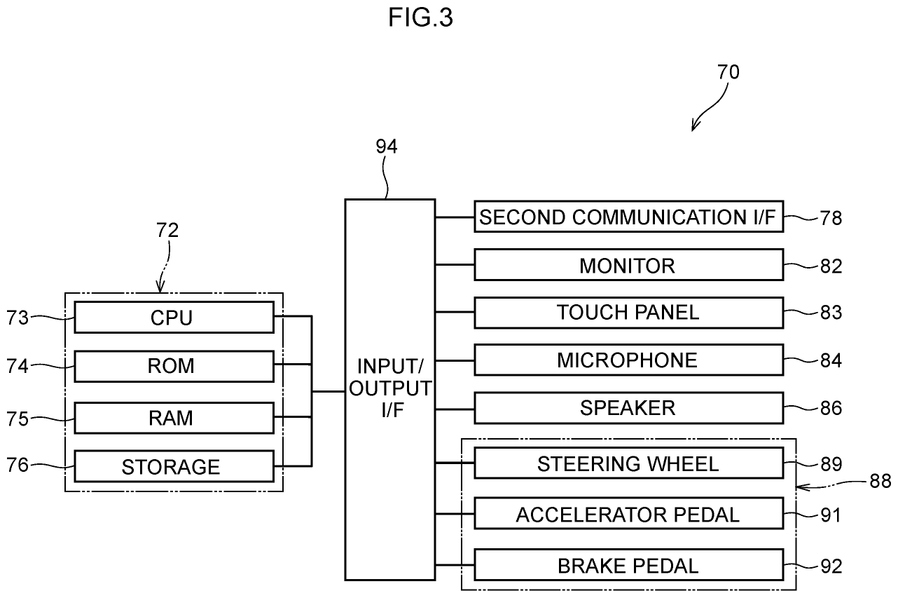

The first communication I/F 48 is connected to the management server 100 communication I/F and a later-described second communication I/F 78 of FIG. 3 via the network N of FIG. 1. The monitor 52 is configured to display various kinds of information obtained by the ECU 42, and notifies the occupant PA by displaying the various kinds of information. The touch panel 53 is formed integrally with the monitor 52, and can input various types of information with respect to the information displayed on the monitor 52. In the touch panel 53, manual operation by the manual operation device 40 and remote operation by the remote operation device 70 can be selected by a switching button. The information selected by the switching button is transmitted to the management server 100.

The microphone 54 acquires the voice of the occupant PA. The voice information obtained by the microphone 54 is transmitted to the remote operation device 70 via the network N in FIG. 1. The speaker 55 converts voice information of the remote operator PB and other information transmitted from the remote operation device 70 into voice and outputs the voice. The belt wearing sensor 56 detects whether or not the wearing of the seat belt 34 of the occupant PA is completed.

The operation unit 58 includes a steering wheel 59, an accelerator pedal 61, and a brake pedal 62. The steering wheel 59 is configured to be able to change the steering angle of the vehicle 30 in FIG. 1 by being rotated around an axis by the occupant PA. The accelerator pedal 61 is configured to be able to change the speed and acceleration of the vehicle 30 by being depressed by the occupant PA. The brake pedal 62 is configured to decelerate or stop the vehicle 30 by being depressed by the occupant PA.

<Remote Operation Device>

As shown in FIG. 3, the remote operation device 70 includes an ECU 72, a second communication interface 78, a monitor 82, a touch panel 83, a microphone 84, a speaker 86, an operation unit 88, and an input/output interface 94.

The ECU 72 has a CPU 73, a ROM 74, a RAM 75, and a storage 76. The ROM 74 stores various types of programs and various types of data. The RAM 75 acts as a workspace for temporary storage of programs and data. The storage 76 is configured by, for example, a flash ROM, and stores various programs including an operating system and various data. The CPU 73 executes various programs recorded in the ROM 74 or the storage 76.

The second communication I/F 78 is connected to the management server 100 communication I/F and the first communication I/F 48 of FIG. 2 via the network N of FIG. 1. The monitor 82 is configured to display various kinds of information obtained by the ECU 72, and notifies the remote operator PB by displaying the various kinds of information. The touch panel 83 is formed integrally with the monitor 82, and can input various types of information with respect to the information displayed on the monitor 82.

The microphone 84 acquires the voice of the remote operator PB. The voice information obtained by the microphone 84 is transmitted to the manual operation device 40 of FIG. 2 via the network N. The speaker 86 converts the voice information of the occupant PA of FIG. 1 and other information transmitted from the manual operation device 40 into voice and outputs the voice.

The operation unit 88 includes a steering wheel 89, an accelerator pedal 91, and a brake pedal 92. The steering wheel 89 is configured to be able to change the steering angle of the vehicle 30 by being rotated around an axis by the remote operator PB. The accelerator pedal 91 is configured to be able to change the speed and acceleration of the vehicle 30 by being depressed by the remote operator PB. The brake pedal 92 is configured to decelerate or stop the vehicle 30 by being depressed by the remote operator PB.

<Management Server>

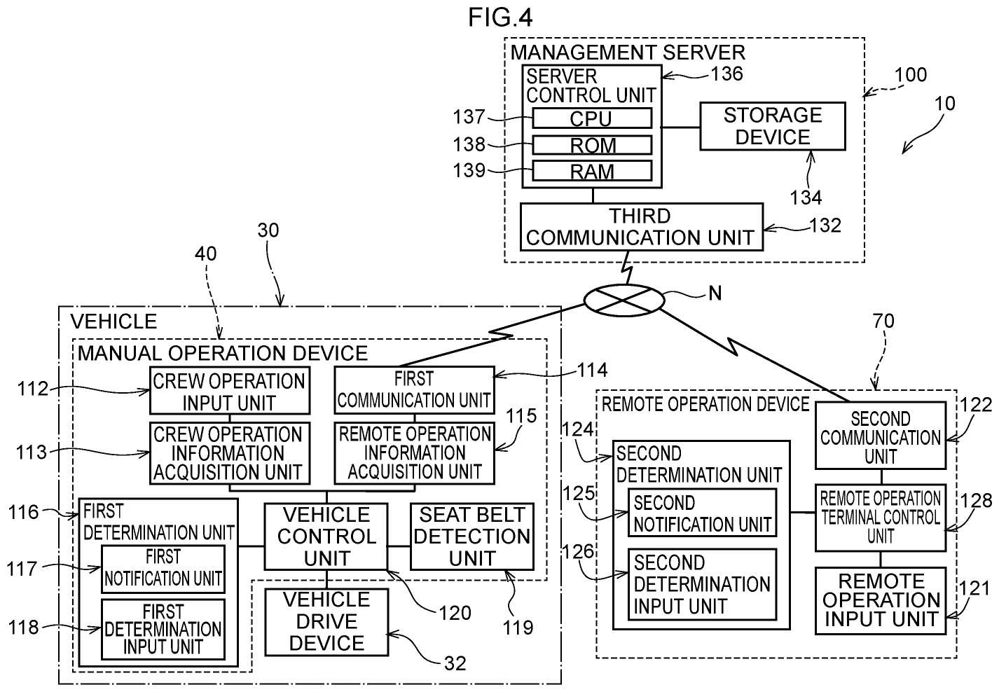

The management server 100 illustrated in FIG. 4 is an example of a permission unit, and includes a CPU 137, a ROM 138, a RAM 139, and a storage. The functions of the ROM 138 and the RAM 139 are the same as those of the ROMs 44 and 74 and the RAMS 45 and 75, and thus description is omitted. The CPU 137 executes the various programs recorded in the ROM 138 or the storage to perform control of switching between the manual operation by the occupant PA on the manual operation device 40 in FIG. 1 and the remote operation by the remote operator PB on the remote operation device 70.

In detail, in the management server 100 shown in FIG. 1, when the manual operation device 40 determines that the remote operator PB can be authenticated and the remote operation device 70 determines that the occupant PA can be authenticated, control is performed to switch between manual operation by the occupant PA and remote operation by the remote operator PB. The switching from one of the manual operation and the remote operation to the other or from the other to the one, is performed in response to a request from the occupant PA such as switching of a switching button on the touch panel 53. That is, in the manual operation state, when the occupant PA desires the remote operation, switching from the manual operation to the remote operation is performed. In the remote operation state, when the occupant PA desires the manual operation, switching from the remote operation to the manual operation is performed.

[Functional Configuration]

The remote driving system 10 shown in FIG. 4 manages—that is, controls—the handover of the driving operation of the vehicle 30 by implementing various functions using the above hardware resources when executing the driving operation handover program. The functional configuration realized by the remote operation system 10 will be described below. In addition, regarding each structure shown in FIG. 1 to FIG. 3, description of an individual drawing number may be omitted.

As an example, the remote driving system 10 includes a first communication unit 114, a second communication unit 122, a first determination unit 116, a second determination unit 124, the management server 100, a first determination input unit 118 as an example of an input unit, a storage device 134, and a seat belt detection unit 119. Here, as an example, these respective units are explained in terms of a manual operation device 40 that is manually operated by the occupant PA, a remote operation device 70 that is remotely operated by the remote operator PB, and a management server 100 that performs a mutual authentication determination.

<Manual Operation Device>

The manual operation device 40 includes, as functional components, an occupant operation input unit 112, an occupant operation information acquisition unit 113, a first communication unit 114, a remote operation information acquisition unit 115, a first determination unit 116, a seat belt detection unit 119 and a vehicle control unit 120. Each functional configuration is realized by the CPU 43 of the manual operation device 40 reading out a program and information stored in the ROM 44 or the storage 46, and developing and executing the program in the RAM 45.

The occupant operation input unit 112 is a part where manual driving of the vehicle 30 by the occupant PA—that is, manual operation—is performed, and information of the manual operation—for example, information such as a steering angle and an accelerator position—is input. In addition, the occupant operation input unit 112 transmits the input information to the occupant operation information acquisition unit 113.

The occupant operation information acquisition unit 113 acquires the information transmitted from the occupant operation input unit 112 and transmits the information to the vehicle control unit 120.

The first communication unit 114 is provided in the manual operation device 40. Further, the first communication unit 114 transmits occupant information relating to the occupant PA who operates the manual operation device 40—that is, information stored in advance—to the remote operation device 70 and the management server 100, which will be described later. Further, the first communication unit 114 receives operator information regarding the remote operator PB. In addition, the first communication unit 114 includes the determination information, the evaluation information, and the seatbelt detection information, which will be described later, in the occupant information, and transmits the occupant information to the remote operation device 70 via the network N.

The remote operation information acquisition unit 115 acquires the operator information on the remote operator PB from the first communication unit 114. Further, the remote operation information acquisition unit 115 transmits the acquired operator information to the vehicle control unit 120.

The first determination unit 116 is provided in the manual operation device 40. In addition, the first determination unit 116 includes, for example, a first notification unit 117 and a first determination input unit 118. The first notification unit 117 notifies the occupant PA of the evaluation information of the remote operator PB stored in the storage device 134 described later, including it in the operator information received by the first communication unit 114. Specifically, the first notification unit 117 is configured to notify the occupant PA of the operator information and the evaluation information by displaying the operator information and the evaluation information on the monitor 52.

The first determination input unit 118 is a part where the occupant PA can determine whether or not the remote operator PB can be authenticated—that is, where the determination is input—when the first notification unit 117 provides notification of the operator information. Specifically, in the first determination input unit 118, the determination information is input by the occupant PA operating the touch panel 53 to select whether or not the remote operator PB displayed on the monitor 52 is authorized.

In the first determination input unit 118, evaluation information on the remote operator PB is input. As an example, the skill of remote operation by the remote operator PB—that is, the level of skill—is input as evaluation information having the three levels of evaluation points 1, 2, and 3. The higher the value of the evaluation point, the higher the evaluation. Selection of the evaluation points—that is, input of the evaluation information is performed by the occupant PA. Then, the first determination input unit 118 transmits the input determination information and evaluation information to the vehicle control unit 120.

The seat belt detection unit 119 is provided in the vehicle 30. In addition, the seat belt detection unit 119 detects the wearing state of the seat belt 34 of the occupant PA. Further, the seatbelt detection unit 119 transmits the detected seatbelt detection information to the vehicle control unit 120.

The vehicle control unit 120 controls the driving of the vehicle driving device 32 based on the manual operation information transmitted from the occupant operation information acquisition unit 113 or the remote operation information transmitted from the remote operation information acquisition unit 115. Further, the vehicle control unit 120 transmits the determination information and the evaluation information input by the first determination input unit 118, the seatbelt detection information detected by the seatbelt detection unit 119, and the occupant information, to the management server 100 via the first communication unit 114 and the network N. Further, vehicle control unit 120 transmits the occupant information and the seatbelt detection information to remote operation device 70.

<Remote Operation Device>

The remote operation device 70 includes a remote operation input unit 121, a second communication unit 122, a second determination unit 124, and a remote operation terminal control unit 128 as functional components. Each functional configuration is realized by the CPU 73 of the remote operation device 70 reading out a program and information stored in the ROM 74 or the storage 76, and developing and executing the program in the RAM 75.

The remote operation input unit 121 is a part where remote driving of the vehicle 30 by the remote operator PB—that is, remote operation—is performed, and information on the remote operation—for example, information such as a steering angle and an accelerator position—is input. Further, the remote operation input unit 121 transmits the input information of the remote operation to the remote operation terminal control unit 128.

The second communication unit 122 is provided in the remote operation device 70. In addition, the second communication unit 122 transmits operator information regarding the remote operator PB that drives and operates the remote operation device 70—for example, information stored in advance—to the manual operation device 40 and the management server 100. Further, the second communication unit 122 receives the occupant information on the occupant PA who operates the manual operation device 40. In addition, the second communication unit 122 includes the determination information and the remote operation information described later in the operator information and transmits the information to the manual operation device 40 via the network N.

The second determination unit 124 is provided in the remote operation device 70. In addition, the second determination unit 124 includes, for example, a second notification unit 125 and a second determination input unit 126. The second notification unit 125 notifies the remote operator PB of the occupant information and the seatbelt detection information received by the second communication unit 122. More specifically, the second notification unit 125 is configured to notify the remote operator PB of the occupant information and the seat belt detection information by displaying the occupant information and the seat belt detection information on the monitor 82.

The second determination input unit 126 is a part where the remote operator PB determines—that is, inputs—whether or not the authentication of the occupant PA is possible when notification of the occupant information is provided by the second notification unit 125. Specifically, in the second determination input unit 126, the determination information is input by the remote operator PB operating the touch panel 83 to select whether or not the occupant PA displayed on the monitor 82 is authorized. Further, the second determination input unit 126 determines whether or not the authentication of the occupant PA is possible based on the occupant information including the seat belt detection information. Then, the second determination input unit 126 transmits the input determination information—that is, information on whether or not the occupant PA is authenticated—to the remote operation terminal control unit 128.

The remote operation terminal control unit 128 transmits the determination information and the operator information input by the second determination input unit 126 to the management server 100 via the second communication unit 122 and the network N. Further, the remote operation terminal control unit 128 transmits the operator information to the manual operation device 40.

<Management Server>

The management server 100 includes a third communication unit 132, a storage device 134, and a server control unit 136 as functional configurations. Each functional configuration is realized by the CPU 137 of the server control unit 136 reading out a program and information stored in the ROM 138 or the storage, and developing and executing the program in the RAM 139.

The third communication unit 132 is provided in the management server 100. In addition, the third communication unit 132 transmits the received occupant information, seat belt detection information, operator information, evaluation information, and determination information to the server control unit 136. Further, the third communication unit 132 transmits authentication information described below to the first communication unit 114 of the manual operation device 40 and the second communication unit 122 of the remote operation device 70 via the network N.

The storage device 134 stores the evaluation information on the remote operator PB input by the first determination input unit 118. Further, the storage device 134 stores the received occupant information, seat belt detection information, operator information, and determination information together with the evaluation information. Further, the storage device 134 transmits each piece of information to the server control unit 136 according to an instruction from the server control unit 136.

The server control unit 136 permits switching of driving operation from one to the other of the manual operation device 40 and the remote operation device 70 or vice versa only when the first determination unit 116 determines that the remote operator PB can be authenticated and the second determination unit 124 determines that the occupant PA can be authenticated. That is, the management server 100 permits the switching of the driving operation only when the mutual authentication is OK. When at least one of the occupant PA or the remote operator PB is not authenticated, the management server 100 does not permit the switching of the driving operation—that is, prohibits the switching. The authentication information of the occupant PA and the remote operator PB in the management server 100—that is, the authentication result information—is transmitted to the manual operation device 40 and the remote operation device 70.

<Monitor Display>

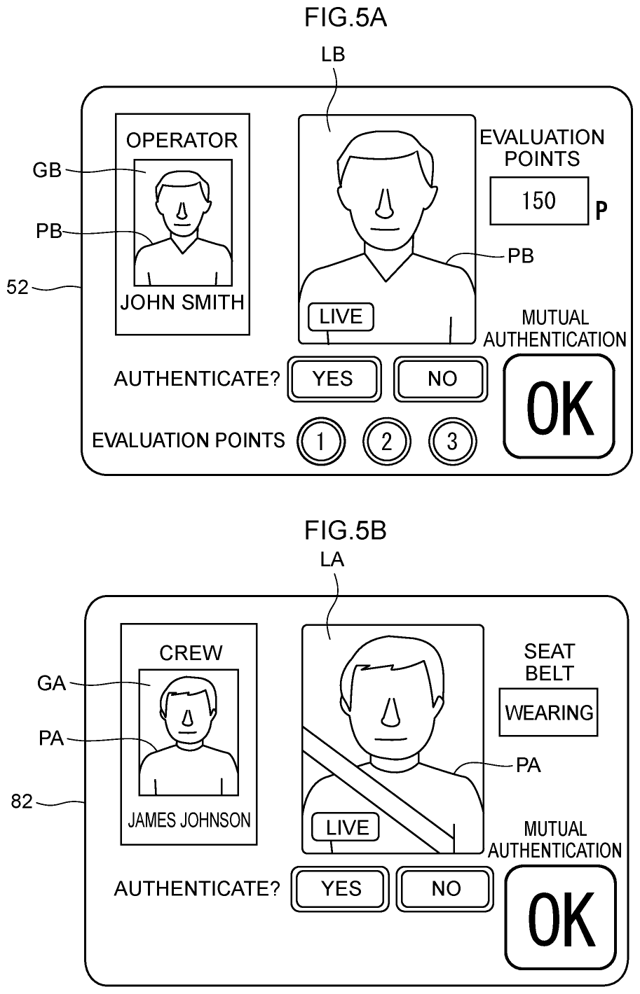

FIG. 5A shows a display example of the notification information and the input information on the monitor 52. The monitor 52 displays, as an example of the notification information, registration information of the remote operator PB, for example, a face photograph GB, a current state of the remote operator PB, for example, a display LB, evaluation points for the remote operator PB, and the result of mutual authentication. This display is when the mutual authentication result is OK. On the monitor 52, as an example of the input information, a selection button “Yes” or “No” for the occupant PA to select whether or not to authenticate the remote operator PB is displayed. The evaluation points 1, 2, and 3 which are evaluation buttons for the occupant PA to evaluate the remote operator PB are also displayed.

FIG. 5B shows a display example of the notification information and the input information on the monitor 82. The monitor 82 displays, as an example of the notification information, registration information of the occupant PA, for example, a face photograph GA, a current state of the occupant PA, for example, a display LA, a seat belt wearing state, and a mutual authentication result. This display is the case where the seatbelt wearing state is OK and the mutual authentication result is OK. The monitor 82 displays, as an example of the input information, selection buttons “Yes” and “No” for the remote operator PB to select whether or not to authenticate the occupant PA.

Explanation follows regarding operation of the remote driving system 10 of the first exemplary embodiment.

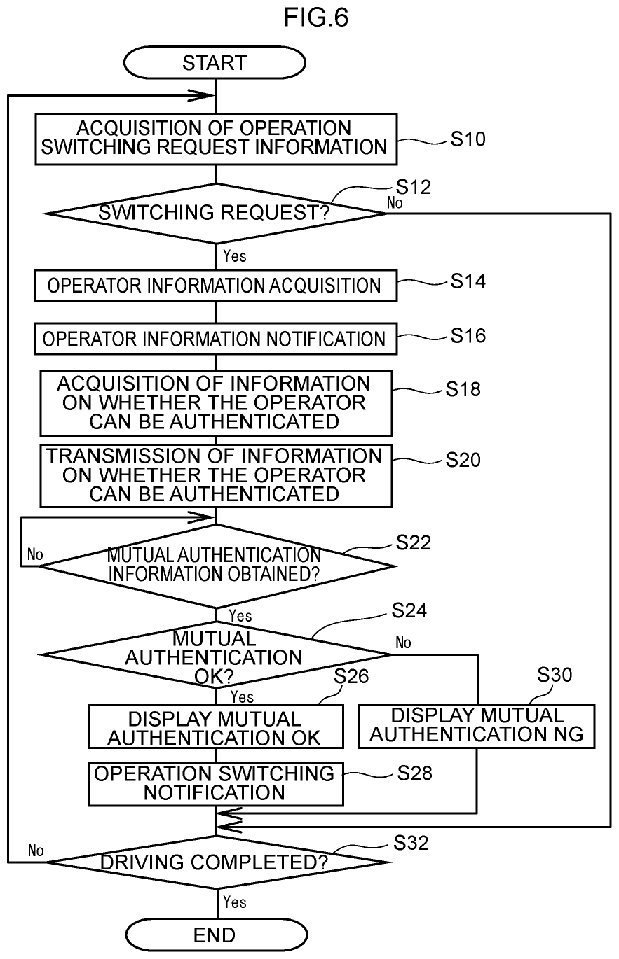

FIG. 6 is a flowchart showing a flow of the driving operation handover process by the ECU 42 of the manual operation device 40 in FIG. 2. In the description of FIGS. 6, 7 and 8, each configuration in the remote operation system 10 refers to each of FIGS. 1 to 4, and the description of individual figure numbers is omitted.

In the ECU 42, the CPU 43 reads out the drive operation takeover program from the ROM 44 or the storage 46, and develops and executes the program in the RAM 45, whereby the drive operation takeover process is performed. Here, description is given on the assumption that the driver PA desires, that is, has requested, the switching of the driving operation from manual operation to remote operation by pressing the switching button.

In step S10, the CPU 43 obtains information on an operation switching request from the occupant PA by detecting ON and OFF of the switching button. Processing then transitions to step S12.

In step S12, the CPU 43 determines whether or not there is an operation switching request. If there is a switching request, that is, if the determination in step S12 is affirmative, the process proceeds to step S14. If there is no switching request, that is, if the determination in step S12 is negative, the process proceeds to step S32.

In step S14, the CPU 43 acquires operator information via the network N. Processing then transitions to step S16.

In step S16, the CPU 43 notifies the first notification unit 117 of the obtained operator information. Processing then transitions to step S18.

In step S18, the CPU 43 acquires from the first determination input unit 118 information on whether the remote operator PB can be authenticated. Here, it is assumed that, as an example, authentication of the remote operator PB is selected. Processing then transitions to step S20.

In step S20, the CPU 43 transmits information on whether or not the remote operator PB can be authenticated to the management server 100. Processing then transitions to step S22.

In step S22, the CPU 43 determines whether or not the mutual authentication information has been obtained from the management server 100. If the mutual authentication information is obtained, that is, if the determination in step S22 is affirmative, the process proceeds to step S24. If the mutual authentication information cannot be obtained, that is, if the determination in step S22 is negative, step S22 is repeated. Note that the mutual authentication information means information indicating whether the authentication of the remote operator PB by the occupant PA and the authentication of the occupant PA by the remote operator PB are both permitted.

In step S24, the CPU 43 determines whether the mutual authentication is possible, that is, OK, or not, that is, NO, based on the acquired mutual authentication information. If the mutual authentication is OK, that is, if the determination in step S24 is affirmative, the process proceeds to step S26. If the mutual authentication is NG, that is, if the determination in step S24 is negative, the process proceeds to step S30.

In step S26, the CPU 43 notifies the first notification section 117 that the mutual authentication is OK; for example, displays the result. Processing then transitions to step S28.

In step S28, for example, the CPU 43 notifies the occupant PA using the speaker 55 that the operation has been switched from the manual operation to the remote operation. Processing then transitions to step S32.

In step S30, the CPU 43 notifies the first notification section 117 that the mutual authentication is NG; for example, displays the result. Processing then transitions to step S32.

In step S32, the CPU 43 determines whether the driving operation has been completed based on the detection result of the ignition sensor. If it is determined that the driving operation has been completed, that is, if the determination in step S32 is affirmative, the program ends. If it is determined that the driving operation is continuing, that is, if the determination in step S32 is negative, the process proceeds to step S10.

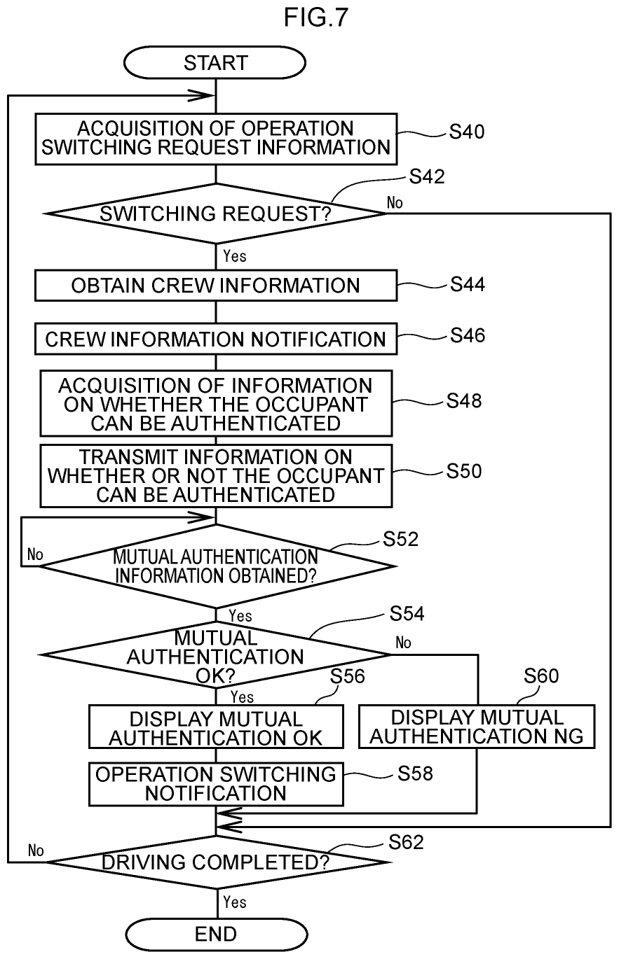

FIG. 7 is a flowchart showing a flow of the driving operation handover process by the ECU 72 of the remote operation device 70 in FIG. 3. In the ECU 72, the CPU 73 reads out the drive operation takeover program from the ROM 74 or the storage 76, and develops and executes the program in the RAM 75, whereby the drive operation takeover process is performed.

In step S40, the CPU 73 acquires information related to a driving operation switching request from the manual operation device 40. Processing then transitions to step S42.

In step S42, the CPU 73 determines whether or not there is an operation switching request. If there is a switching request, that is, if the determination in step S42 is affirmative, the process proceeds to step S44. If there is no switching request, that is, if the determination in step S42 is negative, the process proceeds to step S62.

In step S44, the CPU 73 acquires occupant information via the network N. Processing then transitions to step S46.

In step S46, the CPU 73 notifies the second notification unit 125 of the obtained occupant information. Processing then transitions to step S48.

In step S48, the CPU 73 acquires information on whether or not the occupant PA can be authenticated from the second determination input unit 126. Here, as an example, it is assumed that the authentication of the occupant PA has been selected. Processing then transitions to step S50.

In step S50, the CPU 73 transmits information on whether the occupant PA can be authenticated to the management server 100. Processing then transitions to step S52.

In step S52, the CPU 73 determines whether or not the mutual authentication information has been obtained from the management server 100. If the mutual authentication information is obtained, that is, if the determination in step S52 is affirmative, the process proceeds to step S54. If the mutual authentication information cannot be obtained, that is, if the determination in step S52 is negative, step S52 is repeated.

In step S54, the CPU 73 determines whether the mutual authentication is possible, that is, OK, or not, that is, NO, based on the acquired mutual authentication information. If the mutual authentication is OK, that is, if the determination in step S54 is affirmative, the process proceeds to step S56. If the mutual authentication is NG, that is, if the determination in step S54 is negative, the process proceeds to step S60.

In step S56, the CPU 73 displays at the second notification section 125 that the mutual authentication is OK. Processing then transitions to step S58.

In step S58, for example, the CPU 73 notifies the remote operator PB using the speaker 86 that the operation has been switched from the manual operation to the remote operation. Processing then transitions to step S62.

In step S60, the CPU 73 displays at the second notification section 125 that the mutual authentication is NG. Processing then transitions to step S62.

In step S62, the CPU 73 determines whether the driving operation has been completed based on the detection result of the ignition sensor. If it is determined that the driving operation has been completed, that is, if the determination in step S62 is affirmative, the program ends. If it is determined that the driving operation is continuing, that is, if the determination in step S62 is negative, the process proceeds to step S40.

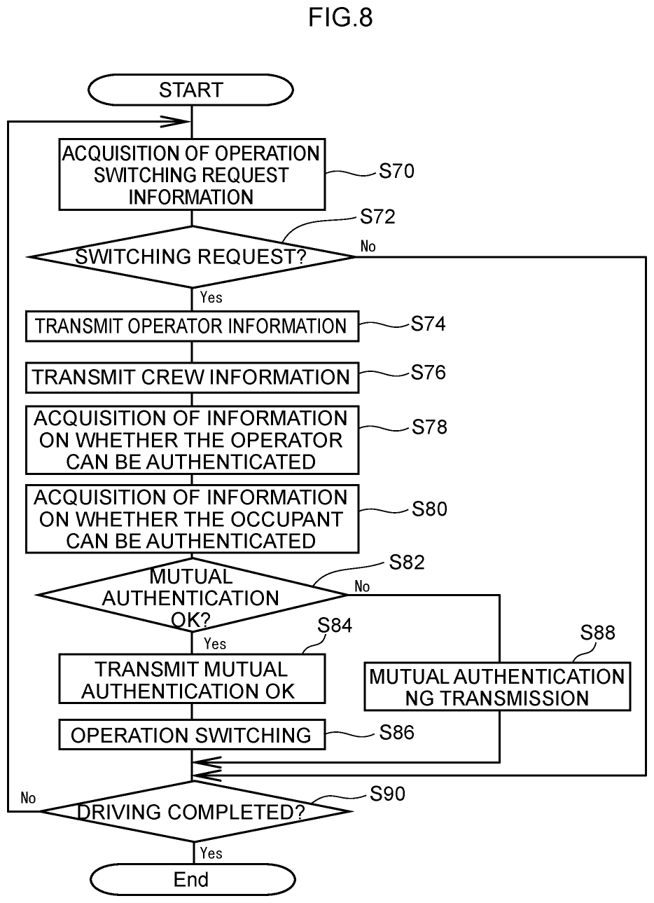

FIG. 8 is a flowchart illustrating a flow of the driving operation handover process performed by the server control unit 136 of the management server 100. In the server control unit 136, the CPU 137 reads out the drive operation takeover program from the ROM 138 or the storage, and develops and executes the program in the RAM 139, whereby the drive operation takeover process is performed.

In step S70, the CPU 137 acquires information related to a driving operation switching request from the manual operation device 40. Processing then transitions to step S72.

In step S72, the CPU 137 determines whether or not there is an operation switching request. If there is a switching request, that is, if the determination in step S72 is affirmative, the process proceeds to step S74. If there is no switching request, that is, if the determination in step S72 is negative, the process proceeds to step S90.

In step S74, the CPU 137 transmits the operator information transmitted from the remote operation device 70 to the manual operation device 40. Processing then transitions to step S76.

In step S76, the CPU 137 transmits the occupant information transmitted from the manual operation device 40 to the remote operation device 70. Processing then transitions to step S78.

In step S78, the CPU 137 acquires information on whether or not the remote operator PB can be authenticated from the manual operation device 40. Here, it is assumed that, as an example, authentication of the remote operator PB is selected. Processing then transitions to step S80.

In step S80, the CPU 137 acquires information on whether or not the occupant PA can be authenticated from the remote operation device 70. Here, as an example, it is assumed that the authentication of the occupant PA has been selected. Processing then transitions to step S82.

In step S82, the CPU 137 determines whether or not the mutual authentication is OK. If the mutual authentication is OK, that is, if the determination in step S82 is affirmative, the process proceeds to step S84. If the mutual authentication is NG, that is, if the determination in step S82 is negative, the process proceeds to step S88.

In step S84, the CPU 137 transmits that the mutual authentication is OK to the manual operation device 40 and the remote operation device 70. Processing then transitions to step S86.

In step S86, the CPU 137 switches the operation from the manual operation device 40 to the remote operation device 70. Processing then transitions to step S90.

In step S88, the CPU 137 transmits that the mutual authentication is NG to the manual operation device 40 and the remote operation device 70. Processing then transitions to step S90.

In step S90, the CPU 137 determines whether the driving operation has been completed based on the detection result of the ignition sensor. If it is determined that the driving operation has been completed, that is, if the determination in step S90 is affirmative, the program ends. If it is determined that the driving operation is continuing, that is, if the determination in step S90 is negative, the process proceeds to step S70.

As described above, in the remote driving system 10, based on the operator information received by the first communication unit 114, the first determination unit 116 determines whether the occupant PA can authenticate the remote operator PB. Further, based on the occupant information received by second communication unit 122, whether or not remote operator PB can authenticate occupant PA is determined by second determination unit 124.

The management server 100 permits switching of driving operation from one to the other of the manual operation device 40 and the remote operation device 70 or vice versa only when the first determination unit 116 determines that the remote operator PB can be authenticated and the second determination unit 124 determines that the occupant PA can be authenticated. As described above, since the driving operation is switched only when the occupant PA and the remote operator PB are mutually authenticated, there is no switching when one of the occupant PA or the remote operator PB is an inappropriate state for the driving operation. Thereby, it is possible to prevent traveling failure of the vehicle 30 due to driving operation failure of the remote operator PB or the occupant PA.

Also, in the remote driving system 10, the first determination unit 116 notifies the occupant PA of the evaluation information of the remote operator PB stored in the storage device 134 by including the evaluation information in the operator information. Accordingly, when the occupant PA determines whether or not the remote operator PB can be authenticated, not only the state of the remote operator PB at the time of the determination but also the past evaluation of the remote operator PB can be considered together, and the occupant PA can, therefore, more accurately assess the remote operator PB. The past evaluation of the remote operator PB is an evaluation by a third party other than the occupant PA and the remote operator PB.

Further, the second determination unit 124 of the remote driving system 10 determines whether or not the authentication of the occupant PA is possible based on the occupant information including the seat belt detection information transmitted from the first communication unit 114. Accordingly, when the remote operator PB determines whether or not the authentication of the occupant PA is possible, the remote operator PB can also consider the seating state of the occupant PA in the seat and, therefore, can more accurately assess the occupant PA.

### Second Exemplary Embodiment

Explanation follows regarding the remote driving system 140 of the second exemplary embodiment.

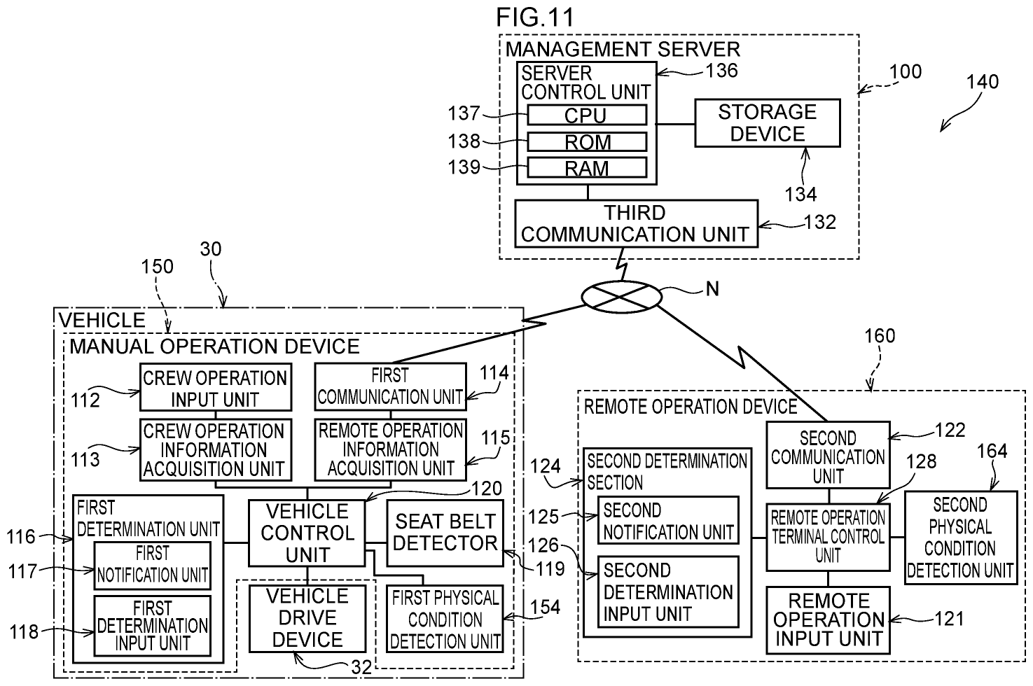

FIG. 11 illustrates an outline of a remote driving system 140. The remote driving system 140 is a system having a vehicle 30 including a manual operation device 150, a remote operation device 160, and a management server 100 as hardware configurations. In addition, about the structure that is basically the same as that of the remote driving system 10 of the first embodiment of FIG. 1, the same reference numerals are attached and description is omitted.

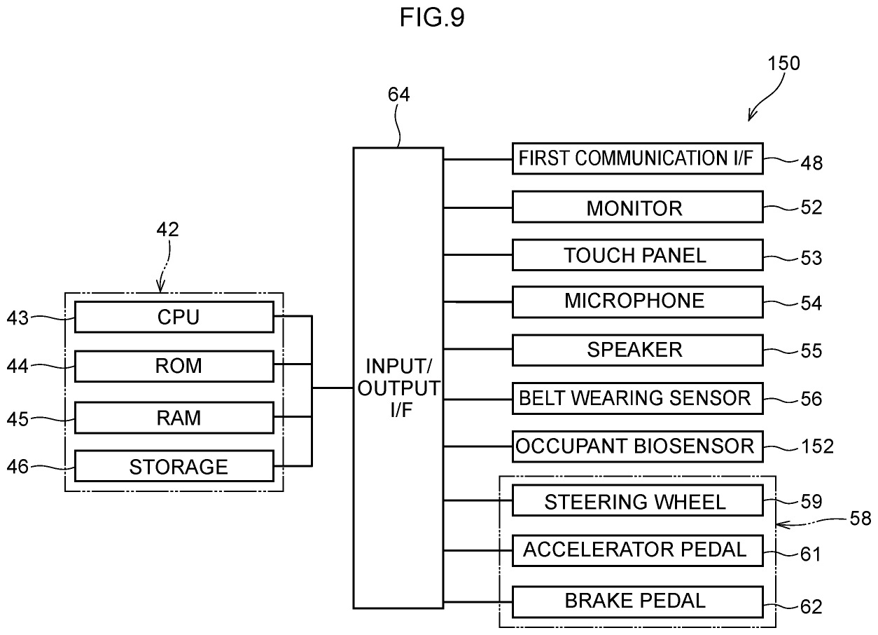

FIG. 9 illustrates an example of a hardware configuration of the manual operation unit 150 according to the second embodiment. The manual operation device 150 differs from the first embodiment in that an occupant biosensor 152 is added to the manual operation device 40 in FIG. 2.

The occupant biosensor 152 detects biological information such as a pulse, brain wave, blood pressure, and heart rate in order to detect the physical condition of the occupant PA in FIG. 1. In addition, the occupant biosensor 152 outputs the detected biometric information to the ECU 42.

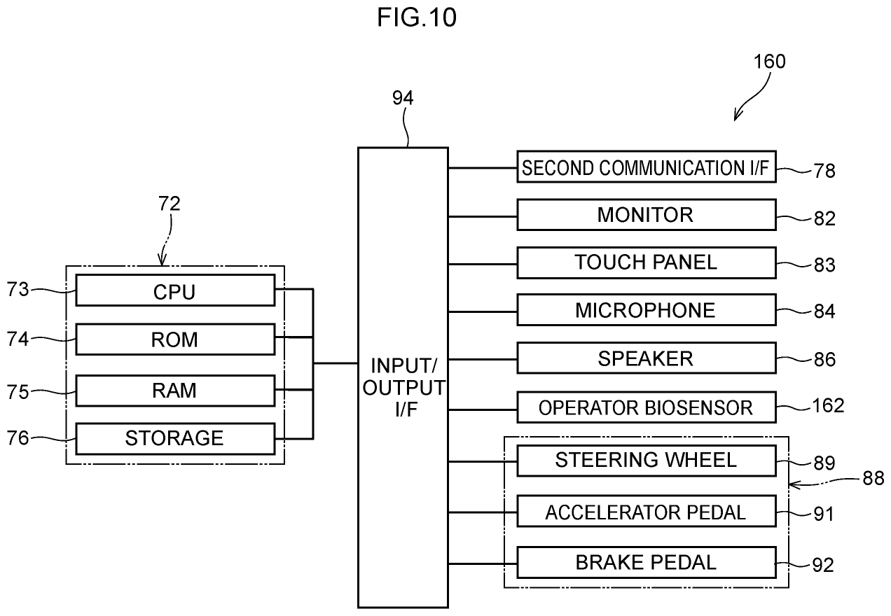

FIG. 10 illustrates an example of a hardware configuration of the remote operation device 160 according to the second embodiment. The remote operation device 160 differs from the first embodiment in that an operator biosensor 162 is added to the remote operation device 70 in FIG. 3.

The operator biosensor 162 detects biological information such as a pulse, brain wave, blood pressure, and heart rate in order to detect the physical condition of the remote operator PB in FIG. 1. In addition, the operator biosensor 162 outputs the detected biometric information to the ECU 72.

As shown in FIG. 11, the manual operation device 150 is provided with a first physical condition detection unit 154 that detects biological information of the occupant PA. The remote operation device 160 is provided with a second physical condition detection unit 164 that detects biological information of the remote operator PB.

The first physical condition detection unit 154 acquires the biological information of the occupant PA using the occupant biosensor 152 in FIG. 9. The biological information of the occupant PA acquired by the first physical condition detection unit 154 is transmitted to the second determination unit 124 of the remote operation device 160 and the management server 100 via the network N.

In the determination of the physical condition of the occupant PA and the remote operator PB, for example, regarding pulse, brain waves, blood pressure, heart rate, and the like, a numerical range in which a normal driving operation is possible is set in advance. If one item exceeds the numerical range, it is determined that the physical condition is poor.

The second determination unit 124 determines whether or not the authentication of the occupant PA is possible based on the occupant information including the biological information of the occupant PA detected by the first physical condition detection unit 154. The determination of the physical condition based on the biological information of the occupant PA may be determined by any of the first determination unit 116, the second determination unit 124, and the server control unit 136.

The second physical condition detection unit 164 acquires the biological information of the remote operator PB using the operator biosensor 162 in FIG. 10. The biological information of the remote operator PB acquired by the second physical condition detection unit 164 is transmitted to the first determination unit 116 of the manual operation device 150 and the management server 100 via the network N.

The first determination unit 116 determines whether the remote operator PB can be authenticated based on the operator information including the biological information of the remote operator PB detected by the second physical condition detection unit 164. The determination of the physical condition based on the biological information of the remote operator PB may be determined by any of the first determination unit 116, the second determination unit 124, and the server control unit 136.

<Monitor Display>

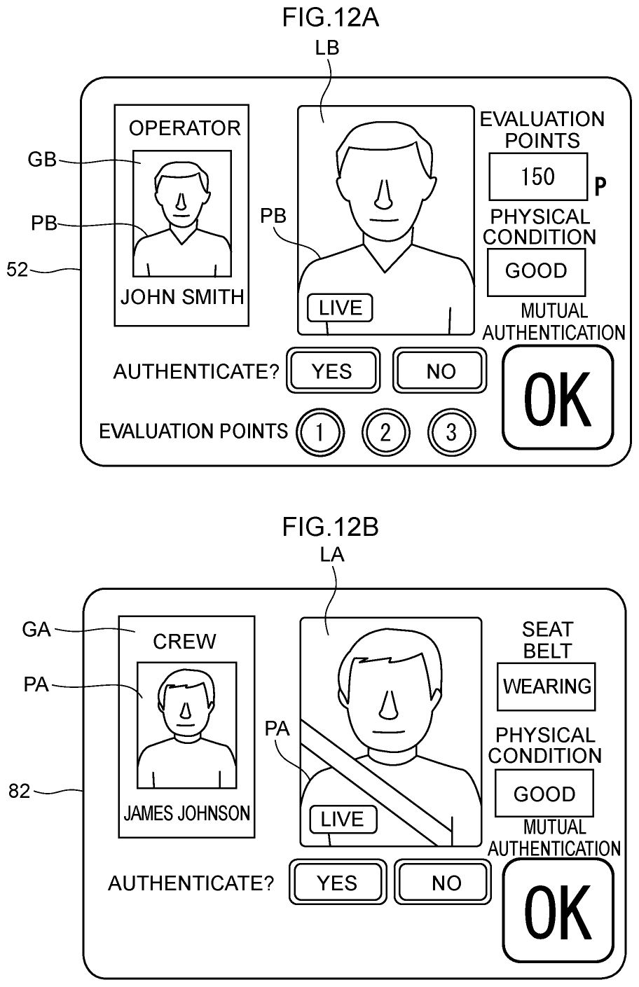

FIG. 12A shows a display example of the notification information and the input information on the monitor 52 of the second embodiment. The monitor 52 displays, as an example of the notification information, registration information of the remote operator PB, a current state of the remote operator PB, evaluation points for the remote operator PB, a physical state of the remote operator PB, and the result of mutual authentication. The monitor 52 displays an authentication selection button and an evaluation button. In the example of FIG. 12A, the physical condition of the remote operator PB is good. If the physical condition of the remote operator PB is bad, for example, “bad” is displayed in the physical condition column. Note that, instead of displaying “bad”, the bad item may be displayed.

FIG. 12B shows a display example of the notification information and the input information on the monitor 82 of the second embodiment. The monitor 82 displays, as an example of the notification information, the registration information of the occupant PA, the current state of the occupant PA, the physical condition of the occupant PA, the wearing state of the seat belt, and the mutual authentication result. The monitor 82 displays an authentication selection button. In the example of FIG. 12B, the physical condition of the occupant PA is good. If the physical condition of the occupant PA is bad, for example, “bad” is displayed in the physical condition column. Note that, instead of displaying “bad”, the bad item may be displayed.

Explanation follows regarding operation of the remote driving system 140 of the second exemplary embodiment. Note that description of operation that is basically similar to that of the remote operation system 10 of FIG. 1 of the first embodiment will be omitted.

The first determination unit 116 of the remote driving system 140 shown in FIG. 11 determines whether the remote operator PB can be authenticated based on the operator information including the biological information of the remote operator PB detected by the second physical condition detection unit 164. The second determination unit 124 determines whether or not the authentication of the occupant PA is possible based on the occupant information including the biological information of the occupant PA detected by the first physical condition detection unit 154. As described above, since switching of the driving operation is performed on the basis of consideration, that is, determination, that includes the physical condition of the occupant PA and the physical condition of the remote operator PB at the time of the determination, a situation in which a driving operation by the occupant PA or the remote operator PB becomes unstable immediately after the switching of the driving operation, can be prevented.

Note that the present disclosure is not limited to the above exemplary embodiments.

In the remote driving systems 10 and 140, the evaluation information on the remote operator PB input by the first determination input unit 118 may be stored in a storage device provided in the manual operation devices 40 and 150 instead of the management server 100. The functional configuration of the management server 100 may be provided in the manual operation devices 40 and 150 or the remote operation devices 70 and 160. Further, in the remote driving systems 10 and 140, the seat belt detection information need not be included in the occupant information.

The method of notifying the occupant PA of information and notifying the remote operator PB of information is not limited to the method of notifying by displaying on the monitors 52 and 82, but may be the method of notifying by sound output from the speakers 55 and 86.

In the remote driving system 140, at least one of a pulse, an electroencephalogram, a blood pressure, and a heart rate may be used as the biological information. Further, as another example of the biological information, the body temperature information of the occupant PA or the body temperature information of the remote operator PB may be used. Furthermore, information on the sitting posture of the occupant PA and information on the sitting posture of the remote operator PB may be included in the biological information.

Further, various types of processors other than a CPU may execute the driving operation handover processing that the CPU executes by reading software (that is, programs) in the above-described embodiments. Examples of the processor in this case include a PLD whose circuit configuration can be changed after manufacturing an FPGA or the like, and a dedicated electric circuit which is a processor having a circuit configuration specifically designed to execute a specific process such as an ASIC. FPGA represents a Field-Programmable Gate Array, PLD represents a Programmable Logic Device, and ASIC represents an Application Specific Integrated Circuit. Moreover, the above-described processing may be executed by one of such processors, or may be executed by a combination of two or more processors of the same type or different types (for example, plural FPGAs, or a combination of a CPU and an FPGA). More specific examples of hardware structures of such processors include electric circuits combining circuit elements such as semiconductor devices.

Moreover, in each of the above exemplary embodiments, cases have been described in which the driving operation handover program is pre-stored (installed) in the ROM or the storage. However, there is no limitation thereto. The program may be provided in a form recorded on a non-transitory recording medium such as a CD-ROM, a DVD-ROM, and a USB memory. Moreover, the driving operation handover program may be provided in a format for downloading from an external device over a network. CD-ROM stands for Compact Disk Read Only Memory, DVD-ROM stands for Digital Versatile Disk Read Only Memory, and USB stands for Universal Serial Bus.

An object of the present disclosure is to provide a remote driving system capable of preventing traveling failure of a vehicle due to driving operation failure by an operator or an occupant.

A remote driving system according to a first aspect includes a first processor; a second processor; and a third processor, in which: the first processor is provided at a manual operation device of a vehicle, and is configured to transmit, to a remote operation device that performs remote operation of the vehicle, occupant information related to an occupant that performs driving operation of the manual operation device, and to receive operator information related to an operator that performs driving operation of the remote operation device, the second processor is provided at the remote operation device and is configured to transmit the operator information to the manual operation device and to receive the occupant information, the first processor is configured to notify the occupant of the received operator information and to determine whether or not authentication of the operator by the occupant is possible, the second processor is configured to notify the operator of the received occupant information and to determine whether or not authentication of the occupant by the operator is possible, and the third processor is configured to permit switching of driving operation from one to another of the manual operation device and the remote operation device only in a case in which the operator has been determined authenticable by the first processor and the occupant has been determined authenticable by the second processor.

In the remote driving system of the first aspect, it is determined whether or not whether or not authentication of the operator by the occupant is possible based on the received operator information. Further, based on the received occupant information, it is determined whether or not authentication of the occupant by the operator is possible. Further, switching of operation from one to the other of the manual operation device and the remote operation device, or vice versa, is permitted only in a case in which the operator has been determined authenticable and the occupant has been determined authenticable. As described above, since the driving operation is switched only in a case in which the occupant and the operator are mutually authenticated, and there is no switching when one of the occupant or the operator is in an inappropriate state for driving operation, it is possible to prevent traveling failure of the vehicle due to driving operation failure by the operator or the occupant.

A remote driving system according to a second aspect is the remote driving system of the first aspect, further including a storage device connected to the third processor, in which: the first processor is further configured to input evaluation information related to the operator, the storage device stores the input evaluation information, and the first processor is configured to include, in the operator information, the evaluation information related to the operator that is stored in the storage device, for notification to the occupant.

In the remote driving system according to the second aspect, the evaluation information of the operator stored in the storage device is included in the operator information for notification to the occupant. Accordingly, in a case in which the occupant determines whether or not the operator can be authenticated, in addition to the state of the operator at the time of the determination, previous evaluation of the operator can be considered as well, and the occupant can, therefore, more accurately assess the operator.

A remote driving system according to a third aspect is the remote driving system of the first aspect, in which: the first processor is further configured to detect a seatbelt wearing state of the occupant, the first processor is configured to include detected seatbelt detection information in the occupant information for transmission to the remote operation device, and the second processor is configured to determine whether or not authentication of the occupant is possible based on the occupant information including the seatbelt detection information.

In the remote driving system according to the third aspect, whether or not the occupant can be authenticated is determined based on the transmitted occupant information including the seat belt detection information. Accordingly, in a case in which the operator determines whether or not the authentication of the occupant is possible, the operator can also consider the seating state of the occupant in the seat and, therefore, can more accurately assess the occupant.

A remote driving system according to a third aspect is the remote driving system of any of the first to third aspects, in which: the first processor is further configured to detect biometric information of the occupant, the second processor is further configured to detect biometric information of the operator, the first processor is configured to determine whether or not authentication of the operator is possible based on the operator information including the biometric information of the operator detected by the second processor, and the second processor is configured to determine whether or not authentication of the occupant is possible based on the occupant information including the biometric information of the occupant detected by the first processor.

In the remote driving system according to the fourth aspect, it is determined whether or not authentication of the operator is possible based on operator information including the detected biometric information of the operator. In addition, it is determined whether or not authentication of the occupant is possible based on occupant information including the detected biometric information of the occupant. In this way, since switching of the driving operation is performed on the basis of consideration that includes the physical condition of the occupant and the physical condition of the operator at the time of the determination, a situation in which a driving operation by the occupant or the operator becomes unstable immediately after the switching of the driving operation, can be prevented.

According to the present disclosure, traveling failure of a vehicle due to driving operation failure by an operator or an occupant can be prevented.

1. A remote driving system, comprising:
a first processor;
a second processor; and
a third processor, wherein:
the first processor that is provided at a manual operation device of a vehicle and is configured to transmit, to the remote operation device that performs remote operation of the vehicle, occupant information related to an occupant that performs driving operation of the manual operation device, and to receive operator information related to an operator that performs driving operation of the remote operation device,
the second processor is provided at a remote operation device and is configured to transmit the operator information to the manual operation device and to receive the occupant information,
the first processor is configured to notify the occupant of the received operator information and to determine whether or not authentication of the operator by the occupant is possible,
the second processor is configured to notify the operator of the received occupant information and to determine whether or not authentication of the occupant by the operator is possible, and
the third processor is configured to permit switching of driving operation from one to another of the manual operation device and the remote operation device only in a case in which the operator has been determined authenticable by the first processor and the occupant has been determined authenticable by the second processor.

2. The remote driving system of claim 1, further comprising a storage device connected to the third processor, wherein:
the first processor is further configured to input evaluation information related to the operator,
the storage device stores the input evaluation information, and
the first processor is configured to include, in the operator information, the evaluation information related to the operator that is stored in the storage device, for notification to the occupant.

3. The remote driving system of claim 1, wherein:
the first processor is further configured to detect a seatbelt wearing state of the occupant,
the first processor is configured to include detected seatbelt detection information in the occupant information for transmission to the remote operation device, and
the second processor is configured to determine whether or not authentication of the occupant is possible based on the occupant information including the seatbelt detection information.

4. The remote driving system of claim 1, wherein:
the first processor is further configured to detect biometric information of the occupant,
the second processor is further configured to detect biometric information of the operator,
the first processor is configured to determine whether or not authentication of the operator is possible based on the operator information including the biometric information of the operator detected by the second processor, and
the second processor is configured to determine whether or not authentication of the occupant is possible based on the occupant information including the biometric information of the occupant detected by the first processor.

5. A remote driving method, comprising:
using a first processor provided at a manual operation device of a vehicle to transmit to a remote operation device that performs remote operation of the vehicle, occupant information related to an occupant that performs driving operation of the manual operation device, and receive operator information related to an operator that performs driving operation of the remote operation device;
using a second processor provided at the remote operation device to transmit the operator information to the manual operation device and receive the occupant information;
using the first processor to notify the occupant of the received operator information and to determine whether or not authentication of the operator by the occupant is possible;
using the second processor to notify the operator of the received occupant information and to determine whether or not authentication of the occupant by the operator is possible; and
using a third processor to permit switching of driving operation from one to another of the manual operation device and the remote operation device only in a case in which the operator has been determined authenticable by the first processor and the occupant has been determined authenticable by the second processor.

6. The remote driving method of claim 5, further comprising,
by the first processor:
inputting evaluation information related to the operator; and
including, in the operator information for notification to the occupant, the evaluation information related to the operator, the evaluation information being stored in a storage device that is connected to the third processor and that stores the input evaluation information.

7. The remote driving method of claim 5, further comprising:
by the first processor, detecting a seatbelt wearing state of the occupant;
by the first processor, including detected seatbelt detection information in the occupant information for transmission to the remote operation device; and
by the second processor, determining whether or not authentication of the occupant is possible based on the occupant information including the seatbelt detection information.

8. The remote driving method of claim 5, further comprising:
by the first processor, detecting biometric information of the occupant;
by the second processor, detecting biometric information of the operator;
by the first processor, determining whether or not authentication of the operator is possible based on the operator information including the biometric information of the operator detected by the second processor; and
by the second processor, determining whether or not authentication of the occupant is possible based on the occupant information including the biometric information of the occupant detected by the first processor.
